(19) United States
(12) Patent Application Publication
(10) Pub. No.: US 2026/0009685 A1
(43) Pub. Date: Jan. 8, 2026

(54) A DEVICE FOR SECURING AND MONITORING LOAD-BEARING ELEMENTS IN BUILDING STRUCTURES

(71) Applicant: FLEXANDROBUST SYSTEMS SPOLKA Z O.O., Krakow (PL)

(72) Inventors: Arkadiusz KWIECIEN, Krakow (PL); Boguslaw ZAJAC, Krakow (PL); Lukasz FEIL, Krakow (PL)

(21) Appl. No.: 19/136,291

(22) PCT Filed: Dec. 1, 2023
(86) PCT No.: PCT/PL2023/000058

§ 371 Date: Jun. 6, 2025

(30) Foreign Application Priority Data
Dec. 6, 2022 (PL) P.443066

(51) Int. Cl. G01L 5/00; G01D 5/353; G01D 21/02

(52) U.S. Cl. CPC G01L 5/00; G01D 5/35316; G01D 21/02

(57) ABSTRACT

A device for securing and monitoring load-bearing elements (1) in building structures contains textile reinforcing material (2) and sensors (6, 7, 8, 9) combined at equal intervals with the textile reinforcing material (2), one of the surfaces of which is covered with a malleable mass polyurethane (4). Fiber optic sensors (6), accelerometers (7), strain gauges (8), linear displacement transformer sensors (9) in a differential arrangement (LVDT) are used. The method of securing and monitoring load-bearing elements in building structures using this device is to clean, dry and remove dust from the protected surface of the load-bearing element (1), then prime it with a polyurethane primer, and then glue the securing and monitoring device.

After the elastic polyurethane mass (4) is completely bonded to the substrate, the positions of individual sensors (6, 7, 8, 9) on the load-bearing element (1) are determined on the protected surface of the load-bearing element (1) and their positions are entered into the system monitoring the condition of the building structure. Then measurement data from individual sensors (6, 7, 8, 9) are recorded at given time intervals and the status of the monitored load-bearing element (1) is determined on an ongoing basis. In a variant of the method, before the stage of cleaning, drying and dedusting the protected surface of the load-bearing element (1), at least one groove is made in it along the direction of its operation, and then, after placing the securing and monitoring device in the groove, it is filled with a single-component, preferably with a setting accelerator, or with a two-component, malleable polyurethane mass (4) and protected against leakage with an adhesive tape, which is removed after the filling of the malleable polyurethane mass (4) has set.

The subject of the invention is a device for securing and monitoring load-bearing elements, especially longitudinal elements such as beams, columns, ceiling slabs, spans in building structures. The device according to the invention protects the structure against sudden destruction, while ensuring continuous monitoring of its condition and operation. The device can also be used to protect and monitor surface elements such as monolithic ceilings or retaining walls.

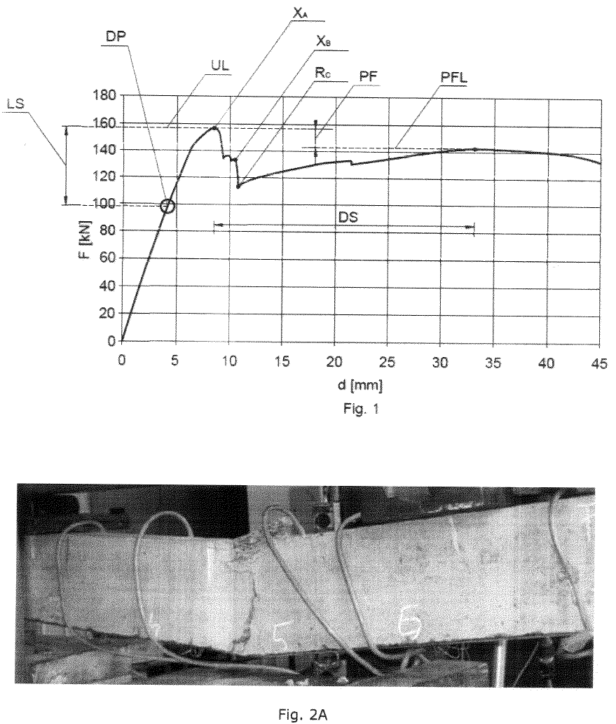

A sudden failure of a structure, e.g. a bridge, occurring without warning, is one of the most dangerous catastrophic events. People are not prepared for them because structures such as bridges are considered safe structures, designed with sufficient load safety factors. In the new generation of the design code, the safety of the structure is ensured by introducing safety factors for loads and for the strength of the structure, i.e. the load capacity of the structure defined as the greatest load that can be sustained (ultimate load—UL), reduced by the above-mentioned safety factors. This procedure determines the so called “design point” (DP) related to the load-bearing axis, the value of which is less than the load-bearing capacity of the structure UL, i.e. its strength, by safe margin of the load (load safety—LS), see FIG. 1. A ratio of the design point DP and the ultimate load UL approximately determines the classic load safety factor (LSF).

$$LSF = DP / UL$$

Catastrophic natural phenomena (earthquakes, strong winds) and man-made causes (overload, corrosion) reduce the structures' load safety LS. Monitoring its various parameters during operation is intended to control and provide early warning about possible danger caused by the structure effort level (DP) being too close to its strength limit UL, i.e. by reducing the safe reserve of LS. The current design philosophy and information about the load safety factor LSF approaching unity, which means a reduction in the LS safety margin, force decisions to be made about renovating or strengthening the structure, reconstructing or reducing loads, because the LSF value must be maintained, e.g. with the DP value at constant level of 70% UL. This approach entails huge costs, especially when the structures in use, e.g. bridges, are significantly corroded and must be taken out of service for a long time during modernization. This also causes high social costs, e.g. in the case of shutting down a bridge on a main road in the mountains, in the highway network or in the city center.

The structure is not consciously allowed to reach its load-bearing capacity (then UL would equal DP, i.e. LSF would equal 1), but over time, for example due to corrosion, the UL value decreases and may become dangerously close to DP. If the safety margin LS is too small, e.g. when LSF=0.95, unexpected overload resulting from sudden or prolonged operation may lead to a critical condition-and cause structural failure or a rapidly progressing disaster. Then, as a result of LSF exceeding the limit value LSF=1, the LSF coefficient ceases to be applicable to the description of the structure, because the ultimate load capacity UL is reduced by the value of the subcritical load drop (post-failure load drop-PF). Its role in the description of the structure is taken over by the post-failure load (PFL), also related to the load-bearing axis, see FIG. 1. Only the structures with a post-failure load capacity capable of carrying their own weight and the operational load temporarily remaining on them, i.e. with a load capacity of not less than 60-90% of the DP value, can continue to safely withstand the loads for a limited period of time. This occurs when these objects are subject to increased deformations, e.g. increased deflections while maintaining a safe subcritical load capacity PFL, characterized by ductile behavior expressing an additional reserve of postcritical safety related to the displacement axis (displacement safety—DS), see FIG. 1. Post-critical condition should be understood as the condition of the structure after permanent deformation or partial destruction of the load-bearing element. Various attempts have been made to seismically secure the structure.

According to the Chinese utility model application CN205399726 U (HENAN XIAN NEW BUILDING MAT CO LTD) regarding buildings with a steel frame made of I-beams (H-beams), the gap between the wall and the horizontal beam can be filled with polyurethane material, which acts as an insulator and improves the aseismicity of the building.

Another Chinese utility model application CN203741998 U (XIAMEN UNIVERSITY OF TECHNOLOGY) presents a method of connecting columns and beams of a steel frame structure by using cushions made of polyurethane inserts at the joints. These inserts separate the clamps from the load-bearing elements fastened with pins and act as shock absorbers absorbing vibration energy at the connections of the load-bearing elements.

In the Japanese patent documents JP2011006896 A (KAZAMA GIKEN KAIHATSU:KK) and JP2000204693 A (KANEGAFUCHI CHEMICAL IND) the use of polyurethane foam to strengthen the building structure and increase its seismic resistance is proposed.

The Polish patent application PL P.377570 (POLITECHNIKA KRAKOWSKA IM. TADEUSZA KOŚCIUSZKI) discloses a method of repairing or strengthening elongated load-bearing elements in building structures, especially beams and girders, consisting in the following steps: relieving the structure, cleaning the surface of the repaired element, preparing external reinforcement in the form of a belt or mat made of carbon, glass or aramid fibers, or at least one flat bar or metal section, preparing an adhesive mass and applying it to the surface of the repaired element, then laying the external reinforcement, removing the relieving load and applying a protective coating. A permanently elastic-plastic polymer mass is used as the adhesive mass, and a test joint made from this mass before the repair between the materials of the element and the external reinforcement has the following ranges of parameters: Young's modulus less than 200 MPa, compressive strength less than 50 MPa, tensile strength less than 20 MPa, shear strength less than 15 MPa, and deformability in the range of 1-500%.

In another Polish patent application PL P.378735 (POLITECHNIKA KRAKOWSKA IM. TADEUSZA KOŚCIUSZKI) a method of securing, repairing or strengthening masonry structures with additional glued reinforcement was proposed, consisting of the following steps: determining the directions of the main tensile stresses on the masonry structure, marking out the lines of additional reinforcement, filling cracks with injection mass, cleaning and preparing the surface of the masonry structure, applying adhesive mass, laying reinforcement and applying a protective coating. A permanently elastic-plastic polymer mass is used as the adhesive mass, and again a test joint made from this mass before the repair between the masonry construction materials and the reinforcement has the following ranges of parameters: Young's modulus less than 200 MPa, compressive strength less than 10 MPa, tensile strength less than 1.5 MPa, shear strength less than 3 MPa and deformability in the range of 1-200%.

There are known methods of protecting buildings against the effects of seismic shocks that use dissipative elements with shape memory. Such technologies are described, among others, in the publication Castellano M. G., Infanti S. “Seismic protection of monuments by shape memory alloy devices and shock transmitters”, 4th International Seminar on Structural Analysis of Historical Constructions, Padova 2004. Shape memory elements increase energy dissipation in a moment of additional deformation, for example resulting from dynamic impact.

The studies known from the state of the art do not solve the issue of increasing safety in the event of a critical failure of an engineering structure while ensuring continuous monitoring of its parameters, especially in the area of deformation or damage to the load-bearing element. This problem is solved by the invention presented below.

The device for securing and monitoring load-bearing elements in building structures, according to the invention, includes a textile reinforcing material and sensors integrated with it, preferably arranged at equal intervals. One of the surfaces of the textile reinforcing material is covered with a malleable polyurethane mass. The sensors are either embedded in the malleable polyurethane mass covering the surface of the textile reinforcing material, or are attached to the surface of the textile reinforcing material on the side opposite to the side covered with this ductile polyurethane mass (then they can be dismantled or replaced), or they are embedded in the structure of the textile reinforcing material. These three variants of placing sensors on/in the textile reinforcement material can be implemented separately or jointly in various combinations.

The sensors are equipped with microprocessor systems with memory for processing and storing measurement data and, preferably, with photovoltaic cells, which makes the securing and monitoring device independent of external power supply. In addition, the sensors can be equipped with transmitters and receivers, making it possible to collect measurement data from subsequent sensors from a safe distance.

The sensors are strain gauges and/or accelerometers and/or linear displacement transformer sensors in a differential arrangement (Linear Variable Differential Transformer—LVDT). Additionally, the securing and monitoring device may have built-in temperature and humidity sensors, acoustic vibration transducers and others. In one implementation, the sensors are equipped with MEMS systems (micro-electromechanical systems), enabling far-reaching miniaturization of the mechanical elements in the sensors.

The sensors can also be equipped with RFID tags operating in the HF and/or UHF and/or SHF standards and using at least one of the frequencies 13.56 MHz, 300-600 MHz, 860-960 MHz, 2.4-2.45 GHz and 5.7-5.8 GHz. Microwave frequencies of the order of gigahertz are of particular interest, because when they are used, measurement readings can be taken from a distance of even a dozen or several dozen meters, and this significantly increases the level of safety of people and equipment involved in monitoring the structures in a post-critical state. Equally important, the sensors with RFID tags do not require power devices, because the energy necessary for their operation is taken from the electromagnetic wave at the moment of contact with the transmitting and receiving central processing and recording device.

Where wireless communication is not justified for any reason, whether due to threat, difficulty in reaching the vicinity of the disaster site, signal shielding or costs, the sensors can be wired by cable to a transmitting and receiving microprocessor processing and recording device.

In one variant of the invention, the securing and monitoring device is equipped with fiber optic sensors, preferably fiber optic Bragg grating sensors. The measurement technique based on the use of optical fibers enables safe measurements in spaces and objects at risk of explosion, because it eliminates the need to use electrical systems, which are always associated with a risk of sparking.

The textile reinforcing material in the securing and monitoring device is a laminate of embedded in polymer carbon fibers (Carbon Fiber Reinforced Polymer—CFRP) or glass fibers (Glass Fiber Reinforced Polymer—GFRP), as well as aramid fibers (Aramid Fiber Reinforced Polymer—AFRP), basalt, geopolymer, steel or natural fibers. The textile reinforcing material can be either a non-woven fabric, a fabric, or a multi-layer laminate. Moreover, it can be made entirely or partially of a Shape Memory Material (SMM), polymers included, preferably of a Shape Memory Alloy (SMA), and especially of a titanium-nickel alloy (NiTi). Favorably, the textile reinforcement material elements made of shape memory material are prestressed.

The malleable polyurethane mass applied to the textile reinforcing material in the securing and monitoring device is either a one-component, preferably with a setting accelerator, or a two-component substance.

The method proposed in the invention for securing and monitoring load-bearing elements in building structures using the above-mentioned securing and monitoring device consists in cleaning, drying and removing dust from the surface of the load-bearing element to be protected, then priming it with a polyurethane primer, and then attaching the securing and monitoring device containing textile reinforcing material with sensors and an applied layer of malleable polyurethane mass. After the elastic polyurethane mass is completely bonded to the substrate on the load-bearing element, the positions of individual sensors are determined on its surface to be protected, and the positions of the sensors are entered into the system monitoring the condition of the building structure.

Then, at any time, measurement data from individual sensors begin to be recorded at given time intervals, and on their basis, the condition of the monitored load-bearing element is determined on an ongoing basis. Time intervals can be selected freely. For example, under conditions of normal operation of the monitored facility, time intervals between measurements may be several hours, and when approaching critical parameters or after a critical situation occurs—several seconds or shorter, depending on the development of the situation. It is recommended to select the values of time intervals on an ongoing basis using the regression method, inversely proportionally to the deformation value of the monitored element (e.g. its elongation or deflection).

In one of the variants of the method according to the invention, before the stage of cleaning, drying and dedusting the surface of the load-bearing element to be protected, at least one groove is made in this element along the direction of its operation, and then, after placing the securing and monitoring device in the groove, it is filled with a single-component, preferably with a setting accelerator, or a two-component malleable polyurethane mass, and protected against flowing with an adhesive tape, which is preferably removed after the polyurethane mass filling has set. Thanks to this, the securing and monitoring device is more closely integrated with the protected element, which increases the effectiveness of the protection and at the same time protects the securing and monitoring device—especially in the phase of a critical event—against damage, for example, against being cut by a reinforcing bar released from the concrete during a disaster.

In another variant of the method, after priming the protected surface of the load-bearing element with a polyurethane primer and before gluing the securing and monitoring device, an additional layer of a single-component, preferably with a setting accelerator, or two-component malleable polyurethane mass is applied to the surface of the load-bearing element, and the securing and monitoring device material is glued only after it has set. This procedure increases the elasticity of the device and, as a result, increases the scope of its deformation in the post-critical state. This allows for even more effective protection of a damaged, e.g. completely torn, structure element and continuation of monitoring of the building's condition.

In order to control the thickness of this additional layer of the malleable polyurethane mass, the spacers are placed in it having a thickness not greater than the assumed layer thickness. The spacers can be of the same thickness along the entire length of the device, e.g. 5 mm, but their thickness can also be varied along or across the device, for example larger in the middle and smaller at the ends or sides, in order to increase the strength of the device at critical points of the structure.

The textile reinforcing material placed on the spacer pads has a predetermined thickness of the malleable polyurethane layer. The spacers are placed (glued) parallel to the protected element, and the longitudinal side gaps are closed with stops. These are made of, for example, self-adhesive tapes and prevent the polyurethane mass from leaking out during filling and setting. The space between the composite textile reinforcing material and the surface of the structural element is filled with a malleable polyurethane mass.

In an additional layer of one-component, preferably with a setting accelerator, or two-component ductile polyurethane mass, one can insert a reinforcing mesh or reinforcing bars made of carbon fibers (CFRP), glass fibers (GFRP), aramid fibers (AFRP), basalt, geopolymer, steel or natural fibers, or a shape memory material (SMM), preferably a shape memory alloy (SMA).

When laying external reinforcement on a malleable polyurethane adhesive mass, a state of longitudinal stress is mechanically induced by the tensioning device (pre-tensioning operation). The state of stress is maintained during the entire period of hardening of the ductile mass until it reaches full strength. The tensioning device can then be released.

The dissipative element containing the shape memory material can also be pre-tensioned. The composite reinforcement can be made entirely of a material with shape memory, especially a titanium-nickel alloy (NiTi).

It is advantageous to combine the laying of additional reinforcement with the use of spacers, as it ensures, strictly controlled over the entire surface of the securing and monitoring device, that the external reinforcement is entirely immersed within the malleable polyurethane mass.

In another variant of implementation, after the stage of priming the protected surface of the load-bearing element with a polyurethane primer, and before the stage of gluing the securing and monitoring device, a layer of prefabricated, malleable polyurethane mass is glued using an adhesive layer made of quick-setting polyurethane glue, and only after the glue hardens, the securing and monitoring device is glued on. This layer of prefabricated, malleable polyurethane mass can be additionally reinforced with reinforcing mesh or reinforcing bars, which—as in the previous variant—are made of carbon (CFRP), glass (GFRP), aramid (AFRP), basalt, geopolymer, steel, natural fibers, or from a shape memory material (SMM), preferably a shape memory alloy (SMA), for example NiTi. As before, the mesh or rods can be pre-tensioned during the prefabrication phase of the tape or sheet made from the malleable polyurethane mass. The device according to the invention protects the structure against brittle, i.e. sudden and following without warning, destruction of the structure being a result of exceeding its designed and actual load-bearing capacity. As mentioned above, such destruction may be caused, for example, by a catastrophic impact (earthquake, hurricane wind, flood), operational and environmental conditions (corrosion) or human error (overload with an excessive load).

The securing and monitoring device proposed here allows the loads to be sustained by the damaged structure in the post-critical state, when unprotected structures are subject to a rapidly progressing catastrophe. The device takes over static and dynamic loads from a damaged, previously working load-bearing system in structures made of various materials: concrete, reinforced concrete, prestressed concrete, steel, aluminum, plastics or wood, as well as masonry and mixed structures. The structure protected by this device does not undergo rapid destruction when its load-bearing capacity is exceeded, but continues to work, bearing loads, even when its deformations (deflections) do not allow the structure to be operated in accordance with the adopted standards. However, the supporting system secured in this way allows for evacuation of people and equipment, or making necessary repairs and security works.

The claimed device introduces an additional reserve of post-critical safety into the structure, enabling saving the lives and property of users staying in the facility and its surroundings, by providing additional time for safe evacuation from the place of danger or enabling the repair of damage in order to continue the safe operation of the facility.

Moreover, the device according to the invention provides constant access to information from monitoring carried out on the structure, both before its failure state and in the post-critical state, when the known devices monitoring the structure are destroyed or cease to provide information about the current condition of the supporting structure. Due to the fact that the proposed device contains a system of measurement sensors which, in the event of a structure failure, still retains the ability to register a signal and transmit it to the monitoring system, it maintains a continuous transfer of information about the location of damage and the development of the object's destruction process, thus supporting safety of its limited use in post-critical condition.

A structure not secured with the device according to the invention is unable to bear its own weight, much less an additional load. The device proposed here does not allow for uncontrolled collapse of the construction, thus protecting people's lives and their property, e.g. on and under a bridge structure, when a damaged and severely deformed structure still hangs on the ductile system according to the invention, see FIG. 2A.

Moreover, in the post-critical state shown in FIG. 2A-2C, traditional systems monitoring the load-bearing capacity of the structure are destroyed and do not provide the user with information about the current post-critical load values. Therefore, it is not possible to make a reliable assessment of whether the destruction process is progressing or whether it is possible to continue staying safely on the damaged structure and its surroundings.

The device according to the invention is both a system protecting the structure and a system monitoring its load-bearing capacity in a post-critical state. Once installed on the structure, it can be a part of the pre-failure monitoring system, and the only system monitoring the structure's operation in the post-failure state.

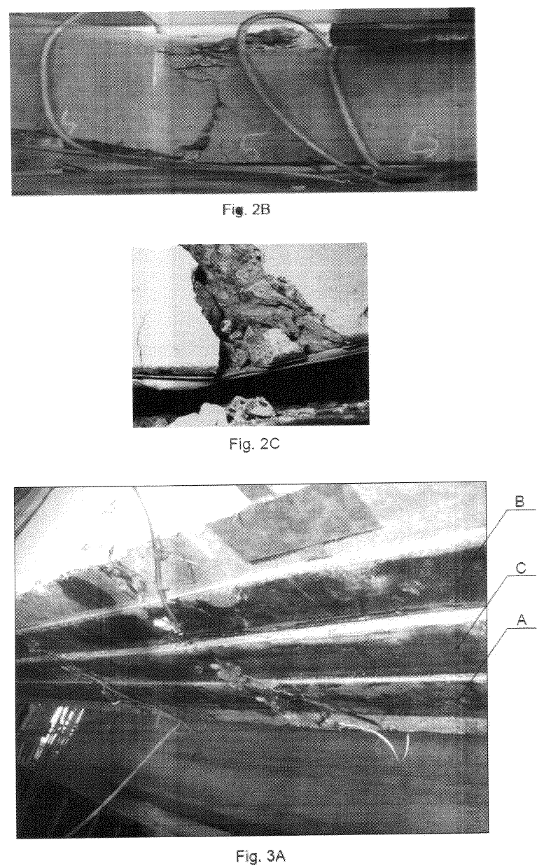

The securing and monitoring device can be installed on an undamaged structure (preventively and for monitoring purposes) and on a structure damaged or weakened by corrosion (as a rescue protection in the event of a failure and need for monitoring the structure in a post-critical condition). It can also be installed on a structure together with a classic reinforcement system using glued composites (FIG. 3A), e.g. carbon fiber laminates (CFRP) classically glued on stiff epoxy resin. In such a situation, in addition to the monitoring function, it can provide protection against a sudden loss of load-bearing capacity of the reinforced structure when classic composite reinforcements suddenly detach from the substrate (see FIG. 3B).

The device and method according to the invention are illustrated in the drawing, in which:

FIG. 1 shows an exemplary characteristic of the structure work in the operational and post-critical range, which has been classically reinforced with CFRP tapes mounted on stiff epoxy resin (tapes A and B) and with the use of a securing and monitoring device according to the invention (tape C);

FIG. 2A shows a view of a damaged reinforced concrete beam, suspended on the device according to the invention and operating in the post-critical range;

FIG. 2B shows a detail of the extensive destruction of a reinforced concrete beam protected by the device according to the invention, with a large crack opening in the tension zone and with crumbled concrete in the compression zone;

FIG. 2C shows a detail of the “notch effect” caused by the impact of the sharp edge of concrete on the device according to the invention and the failure-free operation of the device at this extreme stage of its stress;

FIG. 3A shows a view of a cracked reinforced concrete beam classically reinforced with two CFRP composite tapes classically fastened on stiff epoxy resin (tapes A and B) and secured with a device according to the invention (tape C), operating under load in the operational range just before destruction;

FIG. 3B shows a view of a cracked reinforced concrete beam as in FIG. 3A, operating under load in the post-critical range, with visible detached straps A and B and the device according to the invention (tape C) still operating;

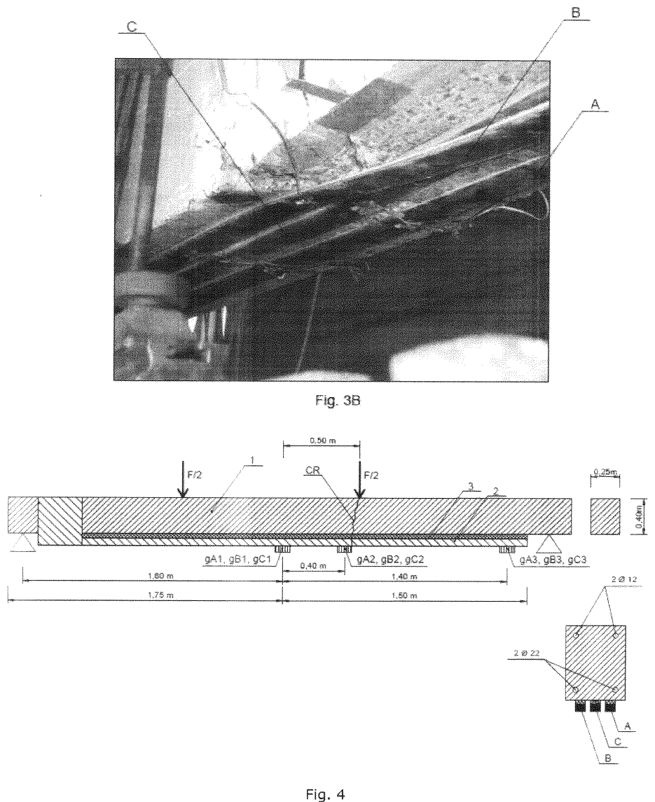

FIG. 4 illustrates a scheme of arrangement and marking of the measurement sensors and other important components of exemplary reinforced concrete beam with a CR crack, reinforced with composite tapes mounted on a layer made of stiff epoxy resin (tapes A and B) and the device according to the invention (tape C);

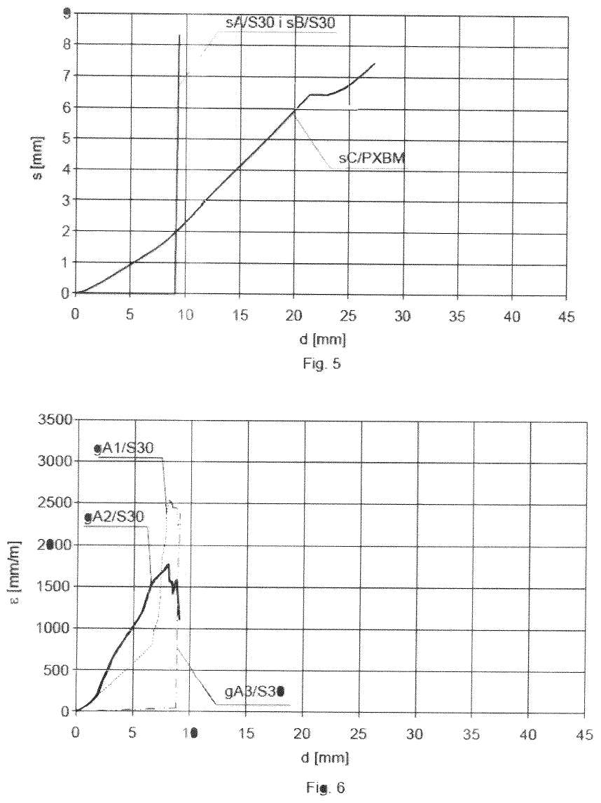

FIG. 5 shows a graph illustrating the differences in the slippage of the ends of belts A and B (sA and sB) and belt C (sC) relative to a reinforced concrete beam, recorded with LVDT sensors for the beam operating in the operational and post-critical condition;

FIG. 6 shows a graph illustrating the differences in deformations recorded by electro-resistive strain gauges (gA1, gA2 and gA3) glued to tape A at various points along the length of the beam working only in the operational state before the tape A was torn off;

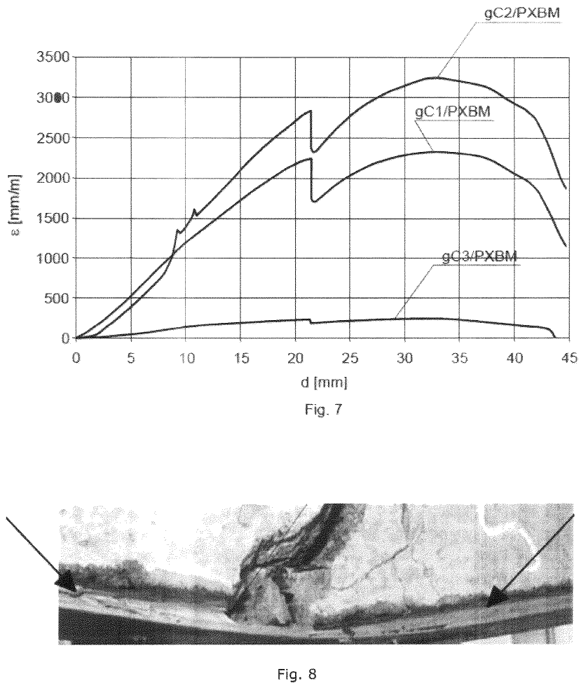

FIG. 7 presents a graph illustrating the differences in deformations recorded by electro-resistive strain gauges (gC1, gC2 and gC3) glued to tape C at various points along the length of the beam working both in the operational state before detachment of the A and B tapes, and in the post-critical state after detachment of the A and B tapes, when only the C belt according to the invention remained in operation;

FIG. 8 shows large deformations of the shape-deforming layer attaching the composite tape to the structure in the securing and monitoring device;

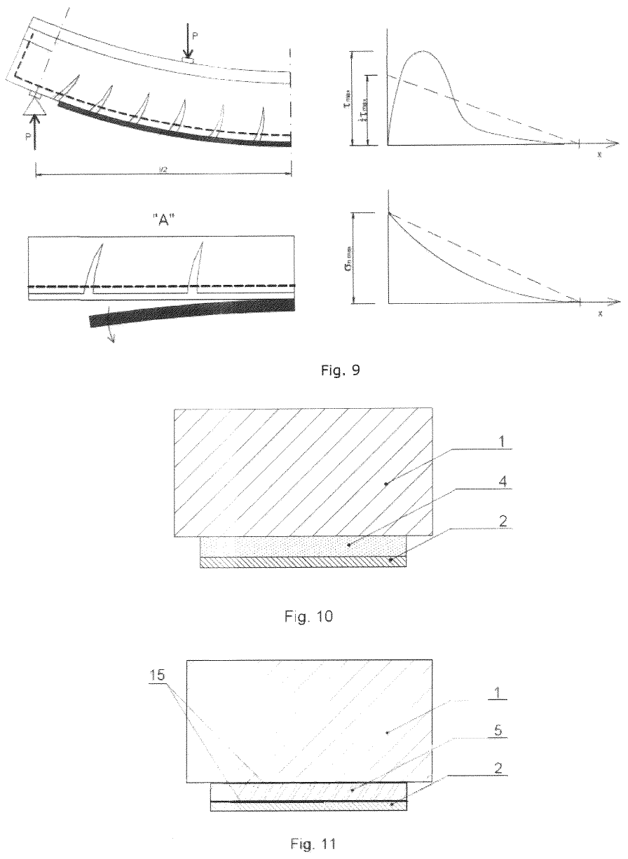

FIG. 9 schematically illustrates the process of detachment of the composite reinforcement mounted on stiff epoxy resins, caused by the action of tangential and normal stresses, the distribution of which along the length of the beam is shown in the graphs;

FIG. 10 shows a cross-section of a load-bearing element in a building structure with a textile reinforcing material attached to it, glued on a malleable polyurethane mass;

FIG. 11 shows a cross-section of a load-bearing element in a building structure with a textile reinforcing material attached to it, glued with a prefabricated elastic polyurethane mass which has been applied to the load-bearing element and the textile reinforcement with the use of quick-setting thin polyurethane adhesive layers;

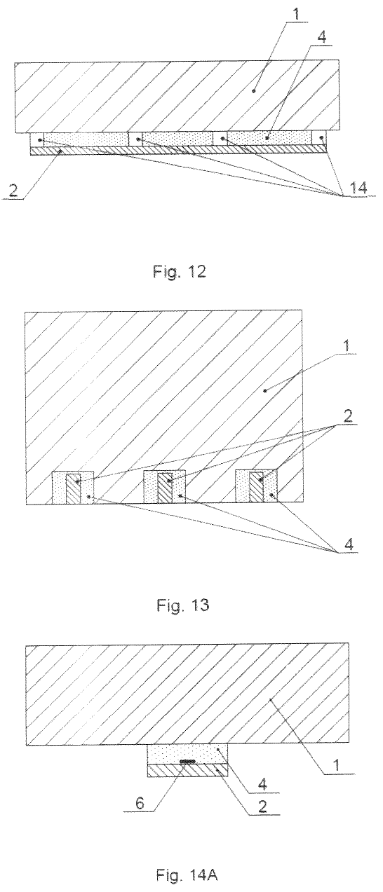

FIG. 12 shows a cross-section of a load-bearing element in a building structure with a textile reinforcing material attached to it, glued to a malleable polyurethane mass with spacers;

FIG. 13 shows a cross-section of a load-bearing element in a building structure with textile reinforcing materials attached to it, glued into grooves cut in the load-bearing element, using a malleable polyurethane mass;

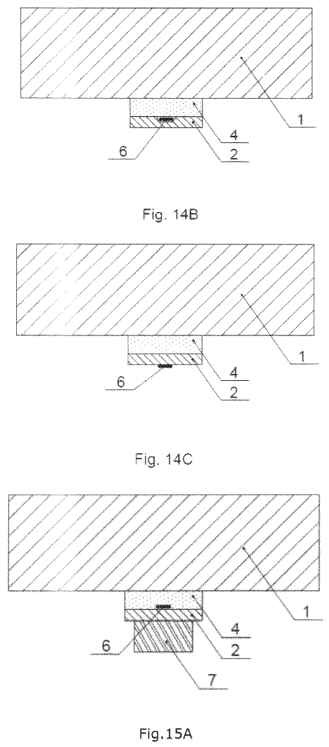

FIG. 14A shows a cross-section of a load-bearing element in a building structure with a textile reinforcing material attached to it, glued on a malleable polyurethane mass, in a variant with a fiber-optic measurement sensor glued to the surface of the load-bearing element from the side of the malleable polyurethane mass;

FIG. 14B shows a cross-section of a load-bearing element in a building structure with a textile reinforcing material attached to it, glued on a malleable polyurethane mass, in a variant with a fiber optic measurement sensor integrated with the textile reinforcing material before being attached with a malleable polyurethane mass;

FIG. 14C shows a cross-section of a load-bearing element in a building structure with a textile reinforcing material attached to it, glued on a malleable polyurethane mass, in a variant with a fiber optic measurement sensor glued to the surface of the textile reinforcing material from the visible external side, which provides access to the sensor;

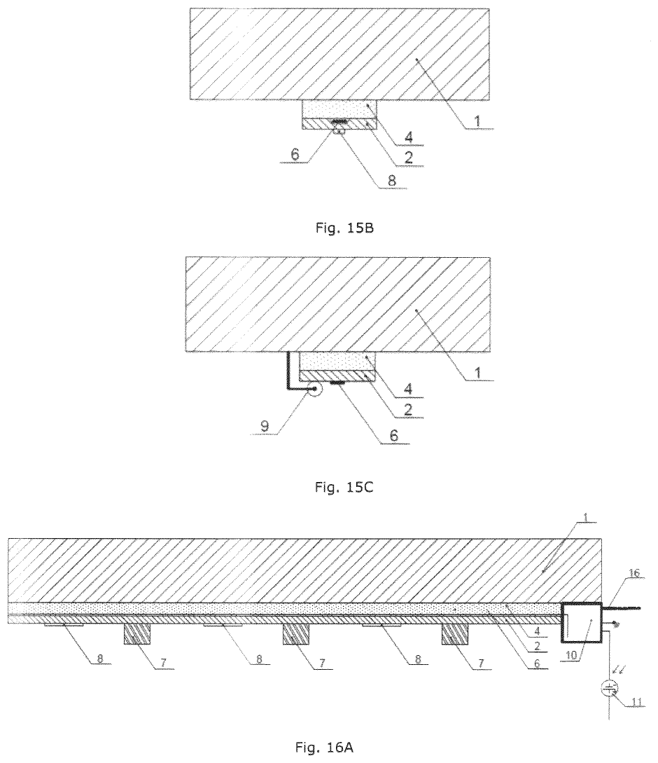

FIG. 15A shows a cross-section of a load-bearing element in a building structure with a textile reinforcing material attached to it, glued on a malleable polyurethane mass, in a variant with a fiber-optic measurement sensor glued to the surface of the textile reinforcing material on the side of the malleable polyurethane mass, with an additionally attached accelerometer;

FIG. 15B shows a cross-section of a load-bearing element in a building structure with a textile reinforcing material attached to it, glued on a malleable polyurethane mass, in a variant with a fiber optic measurement sensor integrated with the textile reinforcing material before fastening with a malleable polyurethane mass, with an additionally attached strain gauge;

FIG. 15C shows a cross-section of a load-bearing element in a building structure with a textile reinforcing material attached to it, glued on a malleable polyurethane mass, in a variant with a fiber optic measurement sensor glued to the surface of the textile reinforcing material from the visible outside, which provides access to the fiber optic sensor, with additionally attached LVDT sensor;

FIG. 16A shows a side view of a load-bearing element in a building structure with a textile reinforcing material attached to it, glued on a malleable polyurethane mass, in a variant with a fiber optic measurement sensor glued to the surface of the textile reinforcing material on the side of the malleable polyurethane mass, with additionally attached accelerometers, strain gauges and a processing and recording device;

FIG. 16B shows a view from the bottom of a load-bearing element in a building structure with a textile reinforcing material attached to it, glued on a malleable polyurethane mass, in a variant with a fiber optic measurement sensor glued to the surface of the textile reinforcing material from the visible outside, with additionally attached accelerometers, strain gauges, LVDT sensor and a processing and recording device;

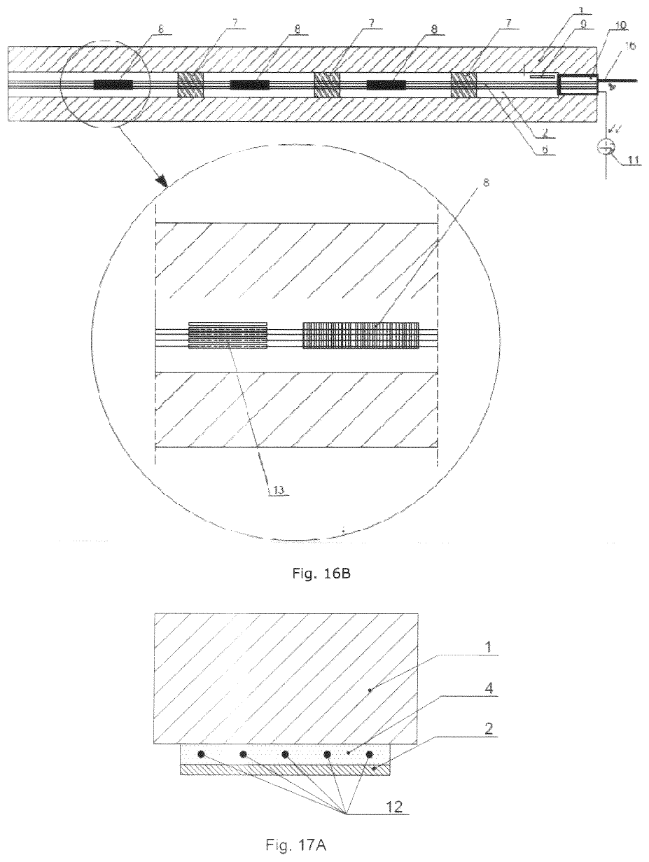

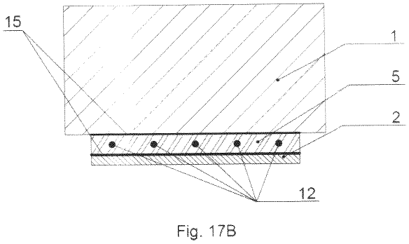

FIG. 17A shows a cross-section of a load-bearing element in a building structure with a textile reinforcing material attached to it, glued on a malleable polyurethane mass; with reinforcing mesh or reinforcing bars embedded in a ductile polyurethane mass;

FIG. 17B shows a cross-section of a load-bearing element in a building structure with a textile reinforcing material attached to it, glued on a prefabricated ductile polyurethane mass applied to the load-bearing element and textile reinforcing material with the use of quick-setting thin polyurethane adhesive layers, with reinforcing mesh or reinforcing bars embedded in prefabricated malleable polyurethane mass.

The unique properties of the securing and monitoring device and the method according to the invention are illustrated in FIG. 1, FIG. 2A-2C and FIG. 3A-3B, which show the principle of operation of the device. Until the structure loses its load-bearing capacity, i.e. until the two CFRP reinforcing tapes classically glued on stiff epoxy resin are suddenly torn off (laminates

A and B), the securing and monitoring device (laminate C) cooperates with the structure without significant changes of its functional features. After the sudden detachment of laminates A and B, the claimed device takes over the entire load due to the structure's own weight and operational load, allowing increased deformations in the structure over a longer period of time, from several minutes to several hours, but while maintaining the required load-bearing capacity on the level of 60-90% of the DP value or higher. The selection of the assumed load-bearing capacity and the duration of its maintenance can be determined using classic calculations in accordance with engineering art. The operation record of the structure protected by the device according to the invention shown in FIG. 1 shows how the deformation (deflection) of the structure changes and in what time. The displacement in millimeters marked on the horizontal axis turns out to be directly proportional to the time in minutes. The load increase to the failure level at which strips A and B separated (marked as XA and XB, respectively) occurred in 11 minutes, which corresponds to a deflection of 11 mm. From that moment (marked as RC in FIG. 1), the entire structure and the given load were suspended on the C band for another 35 minutes, during which time the deflection of the destroyed structure increased by another 35 mm, while the post-critical load capacity of the structure was constantly maintained at a level above 80% of the structure's load-bearing capacity, i.e. the load-bearing capacity at the moment of failure. Laminate C marked in FIGS. 3A-3B was not damaged even with such a strongly deformed structure, enabling uninterrupted operation of the monitoring system.

The principle of operation of the device according to the invention enabling monitoring in post-critical state is a breakthrough approach that goes beyond the current understanding of the safety of bridge-like structures. The invention can extend the life cycle of existing, especially corroded, and newly constructed bridges, as well as increase their safety in the event of threats, e.g. earthquakes. It can be quickly installed on bridge structures to protect them from disastrous consequences.

The composite element is advantageous due to low sensitivity to temperature changes or known compensation parameters, depending on the type of composite used, most often made of CFRP carbon fiber tapes. The device according to the invention introduces an additional safety reserve into the structure after a failure, as it allows obtaining important information in cases where classic monitoring systems are turned off after being damaged during a failure. Monitoring of structures after a failure will allow the immediate transfer of important data to users and authorities, providing online accurate information about the level of safety and its changes. Due to its high adaptivity, the device can cooperate with classic monitoring systems. In the event of a failure, this provides new opportunities to perform measurements and acquire data.

This is illustrated by the case shown in FIG. 3A and 3B, in which sensors were attached, according to the diagram and markings shown in FIG. 4, to CFRP tapes mounted on rigid epoxy resins (laminates A and B) and to the device according to the invention (laminate C) mounted on a malleable polyurethane mass. Electro-resistive strain gauges were used as sensors.

The location of the sensors mounted on the CFRP tapes (laminates A, B and C) are marked with the same letters (gA, gB, gC), while the digital indicators along the length of the beam correspond to: 1—the mid-span of the CFRP tape, 2—the location under the beam crack and 3—the end of the CFRP tape. Additionally, linear displacement transformer sensors in a differential arrangement LVDT were attached to the CFRP tapes, which measured the mutual displacement of the tape ends relative to the beam being a rigid substrate.

The readings from the LVDT sensors are presented in FIG. 5, which shows the lack of slippage of the end of rigidly mounted CFRP tapes (laminates A and B—marked sA/S30 and sB/S30) until the tapes A and B are torn off, visible in FIG. 3B. However, the slippage of the CFRP tape in the operating device according to the invention (laminate C—marking sC/PXBM) is clearly visible also after the sudden detachment of the A and B tapes. The presented slippage of laminate C confirms that the invented securing and monitoring device, when connected to the monitoring system, performs the function of transmitting information about the operation of the structure in a post-critical state. Moreover, only laminate C offers pre-failure, during-failure and post-failure measurement information expressed in curve changes at 8.5 mm, 10.5 mm and 22-27 mm deflection.

FIGS. 6 and 7 show the advantages of the device according to the invention in the measurement range (gC/PXBM) compared to the classic system of strain gauges (gA/S30) mounted on a CFRP tape glued to the structure on rigid epoxy resin (laminate A).

The graph in FIG. 6 shows the operation of strain gauges mounted on CFRP tape glued to stiff epoxy resin. The sensors gA/S30 record the operation of the structure only until tape A is suddenly torn off. In turn, FIG. 7 shows the operation of strain gauges on the CFRP tape in the device according to the invention. The sensors gC/PXBM record the operation of the structure before, during and after the failure, without any disturbance. They can be used to read the moments of detachment of the A and B tapes at a deflection of 8.5 mm and 10.5 mm, and the moment of crushing of the compression zone in the damaged beam at a deflection of 22-27 mm. The time to detach both tapes is 10 minutes, and the time for safe operation of the damaged structure suspended on the C tape is another 35 minutes.

In an embodiment, the device according to the invention consists of a composite reinforcing element: tapes with a width of 10-150 mm and a thickness of 1-5 mm—for example, SikaCarboDur type S, M, XS, S_NSM, rods with a diameter of 6-20 mm—for example, SikaCarboDur BC Rods and fabrics or meshes with a grammage of 300-1000 g/m2 and widths of 100-1000 mm—for example SikaWrap. Fabrics and meshes are made of carbon fiber CFRP or glass, basalt, geopolymer, aramid, steel or natural fibers (e.g. bamboo, jute), for example SikaCarboDur, whose parameters fall in ranges of: Young's modulus 40-500 GPa, tensile strength 100-5000 MPa, ultimate deformability 0.1-5%.

The textile reinforcing material is attached to the structure using special, very flexible and ductile polyurethane masses, two-component or one-component with a setting accelerator, with high elastic recovery and high vibration damping. These masses have parameter stability up to +/−25%, at least in the temperature range from −30° C. to +120° C., with the glass transition temperature Tg being lower than-35° C. The mechanical properties of ductile polyurethane masses are reflected in the parameter values: Shore A hardness after setting in the range of 15-90, constant equivalent stiffness Ez in the range of 0.1-30 MPa, determined in the logarithmic measure of deformation in the stretch range from 1.0 to 1.3 in uniaxial stretching with large deformations, and ultimate stretch in the range of 1.3-10.0.

The selection of ductile polyurethane masses is based on their equivalent stiffness Ez, determined in logarithmic terms over a wide range of large deformations, for engineering deformation in the range of 0-30% (eps=ΔL/L0=0-30%). Due to the hyperelastic (non-linear) nature of the polyurethanes used in the invention, their equivalent logarithmic stiffness Ez is determined according to the formula:

$$Ez = [ F * ( 1 + eps ) ] / [ A 0 * ln ( 1 + eps ) ]$$

where:
F—tensile force, determined by an uniaxial tensile test;
A0—initial cross-section of the stretched element;
ln—natural logarithm;
eps—engineering strain (ratio of the length increase ΔL to the initial length L0).

The equivalent logarithmic stiffness Ez clearly defines the material property of the selected polyurethane, which is used in the calculation of the properties of the polyurethane joint in accordance with the theory of hyperelastic materials.

An important feature determining the selection of polyurethanes for use in the device according to the invention is their viscoelastic feature, which is responsible for long-term or short-term parameters of tensile strength and ultimate tensile deformation. These parameters, important due to the planned operating time of the invention in the post-critical state, are determined on the basis of the variation coefficient k, having values in the range of 0.3-1.3, which multiplies the ultimate engineering strain eps_g and the tensile strength wyt of polyurethane, leading to the modified value of the ultimate strain m_eps_g and the modified value of the tensile strength m_wyt, according to the formulas below:

$$m\_eps \_g = k * eps\_g$$

$$m\_wyt = 2 / 3 * ( m\_eps \_g ) * k * wyt$$

Modified parameters determined in this way can be adopted by engineers in the process of designing the device's operating time.

Due to the 4-5 orders of magnitude lower stiffness of the malleable polyurethane mass working in the securing and monitoring device according to the invention, if compared to the stiffness of the textile reinforcing material, and due to the stiffness of the malleable polyurethane mass working in the device being 3-4 orders of magnitude lower in relation to the stiffness of the protected structures, the measurement system, based on sensors integrated with the textile reinforcing material, is insensitive to temperature changes in the operating range from −20° C. to +60° C. This feature is an additional advantageous property of the invention compared to classic measurement appliances (e.g. electro-resistive strain gauges), which are very sensitive to temperature changes during measurements and must be compensated with additional measurement systems.

The thickness of the malleable polyurethane mass is selected in the range of 1-10 mm based on engineering calculations so as not to exceed its tensile strength m_wyt.

Measurement sensors can be integrated with the textile reinforcing material using system adhesives dedicated to specific types of sensors or embedded in the composite at the stage of its production. In the first case, the sensors can be permanently mounted, dismantled or replaced during operation, or added to already working sensors. Sensors integrated with the textile reinforcing material transmit the signal to an external receiver wirelessly or via a wired system loosely (flexibly) attached to the composite. The textile reinforcing material of the invention is the basis for a system of mounted sensors, which protects the sensors and their cabling system against destruction as a result of structural failure (FIG. 2A-2C and FIG. 8), because the most common reason for excluding sensors from measurements is their damage or delamination caused by damage (cracking, crumbling) of the monitored structure. Integration of the sensors with the reinforcing composite ensures protection and their uninterrupted operation. Controlled, long-term destruction can only occur in the ductile adhesive layer (FIGS. 7 and 8), as a result of exceeding the tensile strength of the polyurethane mass, with large deformations of the shape-deforming layer (FIG. 8), the behavior of which is constantly controlled by a system of sensors integrated with the textile reinforcing material. FIG. 3 shows the process of cohesive destruction of the ductile polyurethane mass (crack in the adhesive layer), which is monitored by strain gauge sensors glued to tape C, showing in FIG. 7 the process of reducing the strain in the tape in the time interval between the 33rd and 45th minute of the test (deflection 33-45 mm).

It should be mentioned here that—unlike the claimed invention using polyurethane resins-the special feature of gluing using epoxy resins is the connection of the structure with the reinforcement in a rigid manner, which limits deformations to tenths of a percent, while ensuring high compressive, tensile and shear strength through of the joint. The epoxy joint has the following parameters: Young's modulus 2-40 GPa, compressive strength 75-100 MPa, tensile strength 20-30 MPa, shear strength 15-20 MPa, deformability below 2%. The high bond rates of such a rigid connection and the advantages of the high-strength reinforcement used, for example made of tapes or mats from CFRP carbon fiber, GFRP glass, AFRP aramid or high-strength steel, are not fully exploited. This is because the effectiveness of reinforcement with high-strength reinforcement and glue is determined mainly by the strength properties of the material of the reinforced structure. Hence, for example, in masonry or concrete structures with low strength of the near-surface zone, destruction occurs through the weaker material of the reinforced structure. This phenomenon is mainly caused by the shear strength of the reinforced structure material being exceeded by the high shear stresses generated in the rigid connection, in which the maximum stress occurs pointwise at the initial edge of the connection, while the stress in the remaining part is much lower. This situation is illustrated in FIG. 9, which shows a schematic view of a reinforced concrete beam, reinforced on the lower, cracked surface by external reinforcement glued on epoxy mass and made of high-strength fibers (composite). The operational load on a reinforced concrete beam with force P causes the stretching of its lower zone and the rigidly connected external reinforcement strip. The initial phase of damage shown in FIG. 9 begins when the shear stresses in the concrete at the edge of the external reinforcement are exceeded. The course of shear and normal stresses in this zone is shown in the graphs. The damage moves further along the joint and the mechanics of this type of destruction are often very sudden and unsignaled. High stress values in a rigid connection also occur in places where there are irregularities in the adhesion of additional reinforcement and in the vicinity of the cracks that have arisen. When using composite tapes, imprecise gluing of the tapes to the structure with a stiff resin leads to transverse tearing of the composite or to sudden breaking the adhesion of the connection.

The method according to the invention is explained with exemplary descriptions of technological operations performed in order to secure an element of the building structure according to the invention, for example a reinforced concrete span beam of a bridge structure.

The description refers to schematic drawings.

On the reinforced concrete span beam 1 of the bridge structure (FIG. 10), which may be undamaged, damaged or reinforced with a composite element glued on stiff epoxy resin, the place of attachment of the reinforcing composite is marked, where the concrete surface is mechanically cleaned of loose particles or cement laitance and dedusted. The marked and cleaned concrete surface is covered with a thin layer of polyurethane primer, compatible with the malleable polyurethane mass intended for application. The carbon fiber tape, constituting the reinforcing composite 2, is cut to the length of the span element to be protected and cleaned of carbon dust on the side in contact with the adhesive mass. The thickness of the adhesive layer determined by engineering calculations (e.g. 5 mm) is ensured by placing on the cleaned surface of the composite tape a single-component elastic polyurethane mass 4 (containing a setting accelerator) in the shape of an equilateral triangle with a height (in the symmetry axis of the tape) twice as high as the assumed thickness of the glue (e.g. 10 mm). Then, the tape 2 with a layer of malleable polyurethane mass 4 placed on it is pressed to the previously primed concrete surface until a uniform thickness of the adhesive mass is obtained on both sides of the edge of the tape 2.

A modification of the variant described above (FIG. 11) is the preliminary preparation of a prefabricated layer of malleable polyurethane 5 of a given thickness, which is first glued to the composite 2 with a quick-setting thin polyurethane adhesive layer 15, and then the aggregate consisting of layer 5 connected with tape 2 is glued to the load-bearing element 1 with the same quick-setting thin polyurethane adhesive layer 15.

Another variant of attaching the composite reinforcement 2 on a malleable polyurethane mass 4 to the load-bearing element 1 (FIG. 12) is to attach spacers 14 with the thickness equal to that of the required adhesive layer and then attach the tape 2. After closing the longitudinal side slots with stops, which can be done most easily using self-adhesive tapes, the space between the reinforcement 2 and the load-bearing element 1 is filled with the malleable polyurethane mass 4 made of liquid two-component polyurethane, which bonds after mixing the two components together.

Another variant of the method presented in FIG. 10 is the case of mounting the tape 2 in dedusted and primed grooves cut in the load-bearing element 1, using a one-component malleable polyurethane mass 4 containing a setting accelerator, as shown schematically in FIG. 13.

The reinforcement of the load-bearing element 1, shown in the cross-section according to FIG. 10 and FIG. 13, is distinguished by the special material of the reinforcement 2, which is made of a shape memory material, in particular a titanium-nickel alloy, which is glued to the load-bearing element 1 in the stretched state relative to that memorized using the single-component mass 4. The obtained compression effect allows for a significant increase in the strength of the load-bearing element 1 without increasing the dimensions of its cross-section.

FIG. 14 shows the load-bearing element 1 with composite reinforcement 2 mounted on a ductile polyurethane mass 4 containing a setting accelerator, the tape 2 being integrated with a measurement sensor or sensors 6, e.g. fiber optic sensors with a Bragg grating 13, which are used for monitoring operation of the protected structure.

The device for securing and monitoring load-bearing elements 1 in building structures, in the first, general embodiment, includes a textile reinforcing material 2 and sensors 6, 7, 8, 9 combined at equal intervals with the textile reinforcing material 2, wherein one of the surfaces of the textile reinforcing material 2 is covered with a malleable polyurethane mass 4.

In a second, specific embodiment, the sensors 6, 7, 8, 9 are attached to the surface of the textile reinforcing material 2 on the side opposite to the side covered with the malleable polyurethane mass 4.

In the third, specific embodiment, the sensors 6, 8 are immersed in a malleable polyurethane mass 4 covering the surface of the textile reinforcing material 2, and in the fourth, specific embodiment, the sensors 6, 8 are embedded in the structure of the textile reinforcing material 2, which may consist of many layers.

Preferably, the sensors 6, 7, 8, 9 are equipped with microprocessor systems with memory and photovoltaic cells 11, as well as with a processing and recording device 10 containing a transmitter and a receiver.

Also preferably, the sensors 6, 7, 8, 9 are equipped with MEMS systems. In specific embodiments of the device according to the invention, the sensors are strain gauges 8 and/or accelerometers 7 and/or linear displacement transformer sensors in a differential arrangement 9 (LVDT).

Additionally, the sensors 6, 7, 8, 9 are equipped with RFID tags operating in the HF and/or UHF and/or SHF standard, and in particular using at least one of the frequencies 13.56 MHz, 300-600 MHz, 860-960 MHz, 2.4-2.45 GHz or 5.7-5.8 GHz.

Alternatively, sensors 6, 7, 8, 9 are connected by a power supply and transmission cable 16 to the transmitting and receiving microprocessor processing and recording device 10.

In another embodiment, the device is equipped with fiber optic sensors 6, preferably fiber optic Bragg grating sensors 13.

The textile reinforcement material 2 is a laminate of polymer-embedded carbon fibers (CFRP) or glass fibers (GFRP), or aramid fibers (AFRP), or basalt fibers, or geopolymer fibers, or steel fibers, or natural fibers. The textile reinforcement material 2 is a nonwoven or woven fabric or a laminate formed by combining nonwoven layers, fabric layers, or nonwoven layers with fabric layers.

In another embodiment of the device according to the invention, the textile reinforcement material 2 is made entirely or partially of a shape memory material (SMM), preferably a shape memory alloy (SMA), which is preferably a titanium-nickel alloy (NiTi). In a particular embodiment of this variant of the device, the elements of the textile reinforcement material 2 made of the shape memory material are prestressed.

Depending on the needs, the malleable polyurethane mass 4 is one-component, preferably with a setting accelerator, or two-component.

The method of securing and monitoring load-bearing elements in building structures using any variant of the securing and monitoring device according to the invention consists in cleaning, drying and dedusting the protected surface of the load-bearing element 1, then priming it with a polyurethane primer, and then sticking the securing and monitoring device containing textile reinforcing material 2 with sensors 6, 7, 8, 9 and an applied layer of elastic polyurethane mass 4, and after the elastic polyurethane mass 4 is completely bonded to the substrate, the positions of individual sensors 6, 7, 8, 9 are marked on the protected surface of the load-bearing element 1, and the positions of the sensors 6, 7, 8, 9 are entered into the system monitoring the condition of the building structure, and then the measurement data from individual sensors 6, 7, 8, 9 are recorded at given time intervals, and current status of the monitored load-bearing element 1 is determined on an ongoing basis, in particular as illustrated in FIG. 1 for the tape (laminate) C. In a variant of the method according to the invention, before the stage of cleaning, drying and dedusting the protected surface of the load-bearing element 1, at least one groove is made in this supporting element along the direction of its operation, and then, after placing the securing and monitoring device in the groove, it is filled with a single-component, preferably with setting accelerator or a two-component elastic polyurethane mass 4 and protected against leakage with an adhesive tape, which is preferably removed after the filling made of elastic polyurethane mass 4 has set.

In another variant of the method according to the invention, after priming the protected surface of the load-bearing element 1 with a polyurethane primer and before sticking the securing and monitoring device, a layer of a single-component, preferably with a setting accelerator, or two-component elastic polyurethane mass 4 is applied to the surface of the load-bearing element 1, and after it has set, the securing and monitoring device is glued to it. Additionally, in this variant of the method according to the invention, spacers 14 having a thickness not greater than the layer thickness are placed in the single-component layer, preferably with a setting accelerator, or in the two-component elastic polyurethane mass 4.

In each of the above variants of the method, when used to secure very heavily loaded load-bearing elements, a reinforcing mesh or reinforcing bars 12 are placed in a single-component layer, preferably with a setting accelerator, or a two-component ductile polyurethane mass 4, wherein the mesh or bars are made of carbon fibers (CFRP) or glass fibers (GFRP), or aramid fibers (AFRP), or basalt fibers, or geopolymer fibers, or steel fibers, or natural fibers, or shape memory material (SMM), preferably shape memory alloy (SMA).

In yet another variant of the method according to the invention, after the stage of priming the protected surface of the load-bearing element 1 with a polyurethane primer and before the stage of gluing the securing and monitoring device, a prefabricated layer of ductile polyurethane mass 5 is glued using a quick-setting thin polyurethane adhesive layer 15, and after bonding of the quick-setting thin polyurethane adhesive layer 15, the securing and monitoring device is glued on. Additionally, especially for securing heavily loaded load-bearing elements, the prefabricated layer of ductile polyurethane mass 5 is reinforced with reinforcing mesh or reinforcing bars 12, wherein the reinforcing mesh or reinforcing bars 12 are made of carbon fibers (CFRP) or glass fibers (GFRP), or aramid (AFRP), or basalt, or geopolymer, or steel, or natural, or shape memory material (SMM), preferably shape memory alloy (SMA).

### REFERENCE MARKINGS

UL—ultimate load
DP—design point
LS—load safety
LSF—load safety factor
PF—post-failure load drop
PFL—post-failure load
DS—displacement safety
XA—detachment of tape A
XB—detachment of tape B
RC—load-bearing element with given load hangs only on tape C
CR-crack
1—load-bearing element in the building structure
2—textile reinforcing material
3—mounting layer made of rigid epoxy glue (laminates A and B) or made of malleable polyurethane mass (laminate C)
4—malleable polyurethane mass
5—prefabricated layer of malleable polyurethane mass
6—fiber optic measurement sensor
7—accelerometer measurement sensor
8—strain gauge measurement sensor
9—LVDT measurement sensor
10—processing and recording device
11—photovoltaic cell
12—reinforcing mesh or reinforcing bars
13—fiber optic sensor with a Bragg grating
14—spacer
15—quick-setting thin polyurethane adhesive layer
16—power supply and transmission cable

1. A device for securing and monitoring load-bearing elements (1) in building structures comprising a textile reinforcing material (2) and sensors (6, 7, 8, 9), characterized in that the sensors are integrated, preferably at equal distances, with the textile reinforcing material (2), and one of a surfaces of the textile reinforcing material (2) is covered with a malleable polyurethane mass (4).

2. The device according to claim 1, characterized in that the sensors (6, 7, 8, 9) are attached to the surface of the textile reinforcing material (2) on a side opposite to a side covered with the malleable polyurethane mass (4).

3. The device according to claim 1, characterized in that the sensors (6, 8) are embedded in a malleable polyurethane mass (4) covering the surface of the textile reinforcing material (2) or the sensors (6, 8) are embedded in the structure of the textile reinforcing material (2).

4. The device according to claim 1, characterized in that the sensors (6, 7, 8, 9) are equipped with microprocessor systems with memory and, preferably, photovoltaic cells (11).

5. The device according to claim 4, characterized in that the sensors (6, 7, 8, 9) are equipped with a processing and recording device (10), preferably containing a transmitter and a receiver.

6. The device according to claim 1, characterized in that the sensors (6, 7, 8, 9) are equipped with MEMS systems.

7. The device according to claim 1, characterized in that the sensors are strain gauges (8) and/or accelerometers (7) and/or linear displacement transformer sensors (9) in a differential arrangement (LVDT).

8. The device according to claim 1, characterized in that the sensors (6, 7, 8, 9) are equipped with RFID tags.

9. The device according to claim 8, characterized in that the RFID tags operate in the HF and/or UHF and/or SHF standard.

10. The device according to claim 9, characterized in that the RFID tags use at least one of the frequencies 13.56 MHz, 300-600 MHz, 860-960 MHz, 2.4-2.45 GHz or 5.7-5.8 GHz.

11. The device according to claim 1, characterized in that the sensors (6, 7, 8, 9) are connected with a transmitting and receiving microprocessor processing and recording device (10) by a power supply and transmission cable (16).

12. The device according to claim 1, characterized in that it is equipped with fiber optic sensors (6), preferably sensors with a fiber optic Bragg grating (13).

13. The device according to claim 1, characterized in that the textile reinforcing material (2) is a laminate of carbon fibers (CFRP) or glass fibers (GFRP), or aramid fibers (AFRP), or basalt fibers, or geopolymer fibers, or steel fibers, or natural fibers embedded in a polymer.

14. The device according to claim 1, characterized in that the textile reinforcing material (2) is a non-woven fabric.

15. The device according to claim 1, characterized in that the textile reinforcement material (2) is a fabric.

16. The device according to claim 1, characterized in that the textile reinforcement material (2) is made entirely or partially of shape memory material (SMM), preferably of shape memory alloy (SMA).

17. The device according to claim 16, characterized in that the shape memory alloy is a titanium-nickel alloy (NiTi).

18. The device according to claim 16 of 17, characterized in that the elements of the textile reinforcing material (2) made of shape memory material are pre-tensioned.

19. The device according to claim 1, characterized in that the malleable polyurethane mass (4) is one-component, preferably with a setting accelerator, or two-component.

20. A method of securing and monitoring load-bearing elements in building structures using securing and monitoring devices, characterized in that the protected surface of the load-bearing element (1) is cleaned, dried and dedusted, then it is primed with a polyurethane primer, and then a securing and monitoring device containing textile reinforcing material (2) with sensors (6, 7, 8, 9) and applied on it a layer of malleable polyurethane mass (4) is glued on the load-bearing element (1), and after the elastic polyurethane mass (4) is completely bonded to the substrate, the positions of individual sensors (6, 7, 8, 9) are marked on the protected surface of the load-bearing element (1), and the positions of the sensors (6, 7, 8, 9) are entered into the system monitoring the condition of the building structure, and then measurement data from individual sensors (6, 7, 8, 9) are recorded at given time intervals and the current status of the monitored load-bearing element (1) is determined.

21. The method according to claim 20, characterized in that before the stage of cleaning, drying and dedusting the protected surface of the load-bearing element (1), at least one groove is made in this load-bearing element along the direction of its operation, and then, after placing the securing and monitoring device in the groove, it is filled with a single-component, preferably with a setting accelerator or a two-component malleable polyurethane mass (4) and protected against flowing with an adhesive tape, which is preferably removed after the filling made of malleable polyurethane mass (4) has set.

22. The method according to claim 20, characterized in that after the step of priming the protected surface of the load-bearing element (1) with a polyurethane primer, and before the step of gluing the securing and monitoring device, a single-component, preferably with a setting accelerator, or a two-component layer of malleable polyurethane mass (4) is applied to the surface of the load-bearing element (1), and after it sets the securing and monitoring device is glued on.

23. The method according to claim 22, characterized in that the spacers (14) with a thickness not greater than the layer thickness are placed in the single-component, preferably with a setting accelerator, or two-component layer of malleable polyurethane mass (4).

24. The method according to claim 23, characterized in that a reinforcing mesh or reinforcing bars (12) are placed in the single-component, preferably with a setting accelerator, or two-component layer of malleable polyurethane mass (4), the mesh or bars being made of carbon fibers (CFRP) or glass fibers (GFRP), or aramid fibers (AFRP), or basalt fibers, or geopolymer fibers, or steel fibers, or natural fibers, or shape memory material (SMM), preferably shape memory alloy (SMA).

25. The method according to claim 24, characterized in that after the step of priming the protected surface of the load-bearing element (1) with a polyurethane primer and before the step of gluing the securing and monitoring device, a prefabricated layer of malleable polyurethane mass (5) is glued with a quick-setting polyurethane adhesive layer (15), and after bonding the quick-setting thin polyurethane adhesive layer (15), the securing and monitoring device is glued on.

26. The method according to claim 25, characterized in that the prefabricated layer of malleable polyurethane mass (5) is reinforced with a reinforcing mesh or reinforcing bars (12), wherein the reinforcing mesh or reinforcing bars (12) are made of carbon fibers (CFRP) or glass fibers (GFRP), or aramid fibers (AFRP), or basalt fibers, or geopolymer fibers, or steel fibers, or natural fibers, or shape memory material (SMM), preferably shape memory alloy (SMA).
